(19) United States
(12) Patent Application Publication
(10) Pub. No.: US 2018/0146370 A1
(43) Pub. Date: May 24, 2018

(54) METHOD AND APPARATUS FOR SECURED AUTHENTICATION USING VOICE BIOMETRICS AND WATERMARKING

(71) Applicants: Ashok Krishnaswamy, Edison, NJ (US); Chandrasekar Mohan Ram, Chennai (IN)

(72) Inventors: Ashok Krishnaswamy, Edison, NJ (US); Chandrasekar Mohan Ram, Chennai (IN)

(21) Appl. No.: 15/358,563

(22) Filed: Nov. 22, 2016

(51) Int. Cl. H04W 12/06; H04L 29/06; G06F 17/30; G10L 17/06; G10L 19/018

(52) U.S. Cl. CPC H04W 12/06; H04L 63/0861; G10L 19/018; G06F 17/30743; G10L 17/06; G06F 17/30864

(57) ABSTRACT

An apparatus including a computer processor, and a computer memory. The computer processor may be programmed to receive a voice input of a first person and a request for authorization by the first person to access an account from an authorized computer software application; to perform audio watermark recognition technology on the voice input to determine if the voice input satisfies expected audio watermark data stored in the computer memory for a first authorized person; to perform voice biometric technology on the voice input to determine if the voice input satisfies expected voice biometric data stored in the computer memory for the first authorized person; and to produce an output to the authorized computer software application to indicate that the voice input is from the first authorized person, based at least in part on the voice input satisfying expected audio watermark data and expected voice biometric data.

### FIELD OF THE INVENTION

This invention relates to improved security methods and apparatus concerning speaker recognition to prevent spoofing or mimicry attempts of authorized users'/customers' voice for a transaction authentication.

### BACKGROUND OF THE INVENTION

With present day threats related to cyber attacks and identity hijacks, enterprises or businesses face a huge challenge in verifying genuine users without compromising customer experience. They face a dilemma, as it often seems that better experience may need to be compromised for security. Many advanced organizations have adopted secondary methods like One-Time Password (OTP), using phone or Passive Voice Biometrics etc. However, still these are not fully safe, as industry has seen duplicate SIM usage for OTP or spoofing in voice biometric with playback/voice simulator etc. Billions of dollars are being lost by large financial services businesses where security has been compromised by an imposter gaining the identity of a high net worth human being or individual (HNI) or a large enterprise or business.

In the last two decades, tremendous growth has occurred in the area of information access and dissemination. The digitization brought much easier, efficient and cost effective method of information storage, retrieval, manipulation and propagation through self-service portals. At the same time some loopholes in these technologies have been utilized effectively by unauthorized individuals and entities, especially, with regards to more sensitive banking and financial data. It is analogous to exposing a treasure in the middle of a road and providing access for authorized people, however, unauthorized people are improperly finding a way to access the treasure. The world is eagerly searching for a fool proof and stable method for information access and transaction control.

Most of the voice based self-service and call center applications rely on “out-of-band” security which use stored TPIN (Trading Partner Identification Number) or OTP (One Time Password) sent via SMS (Short Message Service)/e-mail and account related information combination (with or without encrypted transfers). However, most of these organizations may have at least one story about the insecurity they faced. Authentication by a TPIN is a basic and weak form of user authentication. An entity's TPIN can be easily guessed or compromised by someone who is watching or “shoulder surfing” as a user enters their personal information. Moreover, there are many advanced methods for finding passwords. Despite this, many organizations rely only on a TPIN method for information access and transaction control. When a password has been stolen or otherwise compromised, the victim usually has no idea that their identity has been stolen and the thief is free to act without risk of discovery. The criticality of such threats is more serious when it happens for information in domains like banking, finance, military, and security.

Password based security systems mainly focus on the infrastructure and technology setup in the information source. However, studies show that most of security breaches are happening at the user nodes. Some of these security breaches are: (1) social engineering, (2) password cracking tools, (3) network monitoring, (4) brute force attacking, and (5) abuse of administrative tools. In the case of OTP, using an out-of-band-authentication service provided by a bank or financial service organization, a SIM (Subscriber Identity Module) card swap allows fraudsters to intercept the SMS (short message service) authorization facility, which may lead to account takeover and/or identity theft. Many large banks have reported huge losses of money and trust due to SIM swap conditions especially of HNIs (high net worth individuals).

Passwords can authorize the access, but the challenge is to check whether the right person is accessing the information or executing a transaction. The self-service and call center system needs to authenticate individuals before providing authorization. Authentication relies on identifying unique characteristics—ideally one or more biometric characteristics which cannot be replicated by anybody else in the world.

Out of various biometrics methods such as voice biometrics, finger print biometrics, iris scan, face biometrics etc, the most desirable one, according to surveys among users is voice biometrics, due to convenience and non-intrusive nature. Also, technology is now mature enough and can be deployed in a distributed network, as many leading banks including Citibank (trademarked), have implemented over seventy million voice print enrollments in the past one year.

Generally, voice biometrics makes use of various sound and habitual parameters like frequencies, pattern of talking, timbre etc. It offers major advantages over other authentication techniques in terms of usability, scalability, and cost, case of deployment and user acceptance. Moreover, voice biometrics is the only method which doesn't requires any special hardware or reader for the user. Voice biometrics, comprises two distinct phases—speaker identification and verification. According to the leading voice-based biometrics analyst J. Markowitz, speaker identification is the process of finding and attaching a speaker identity to the voice of an unknown speaker, while speaker verification is the process of determining whether a person is who she/he claims to be.

Today organizations are moving away from traditional T-PIN based security systems and are in search of a more complex and fool proof methods using multiple authentication with Biometrics and unique characteristics of individuals, to avoid faking of identity by a fraudster. They are also considering the fact that complexity should not lead to customer irritation and/or anxieties that leads to dis-satisfaction among the customers. Here is where our invention scores over many other techniques, available prior to invention, due to superior customer experience using passive detection and verification of customers with Voice Biometrics and Watermark unique to customer, as they explain their requirement or statement of calling the helpline.

Speaker recognition/verification system is used for the purpose of securing the transaction and information dissemination through self-service portals and voice call centre system, there are many challenges in speaker recognition system, which directly or indirectly affect the system efficiency.

One such important parameter is voice conversion/playback which is also known as spoofing attack. In spoofing attack a speaker's speech is produced in source side and is modified and played back to sound like the speaker's original voice.

Mostly two popular spoofing attack methods include speech synthesis system and a human mimicking the voice of the customer of a bank or enterprise to illegally gain access to transactions. In speech synthesis a source voice sample is manipulated/trained to sound like the target speaker's speech. In human voice mimicking a person tries to generate speech like the target speaker or target's speech is recorded and then played back.

Although studies have shown that human can easily distinguished between synthesized and natural speech, it is difficult even for human to distinguish play-back attacks.

### SUMMARY OF THE INVENTION

In view of providing a more or most secured method of authentication, in one or more embodiments of the present invention, which can be called “Secure Voiz” (SVoiz) combine watermark technology (audio or image, as chosen by user) combined with voice biometric technology. One or more embodiments of the present invention provide higher security as Subscriber Identify Module (SIM) replication or a “Spoofing” attack will not be possible, as watermark will need to be chosen by an end user (visual or audio method), which will not be known to imposter.

Moreover, in one or more embodiments, the delivery is made more secured thru a hardware based contrivance/device that can work with most of the PBX/CTI equipment, which is unique part of one or more embodiments of the present invention. “PBX” means public branch exchange or public telephone switchboard, and “CTI” means computer telephony integration. The end-to-end embedded encryption and hacking-proof protection layers of the one or more embodiments of the present invention, provide an additional layer of security for authenticating a user in a remote channel like phone or internet etc.

There are possibilities of a spoofing attack in a recognition system, which break the security system. By using the watermark technology, in accordance with one or more embodiments of the present invention, authenticity information can be hidden within a voice biometric print. This hidden watermark information combined with voice biometrics and other unique ID (identification) is used, in one or more embodiments of the present invention, as a robust and reliable method in a speaker recognition/verification system.

Speaker recognition/verification system is used for the purpose of securing a transaction and information dissemination through self-service portals and a voice call center system, there are many challenges in speaker recognition system, which directly or indirectly affect the system efficiency.

One such important parameter is voice conversion/playback which is also known as spoofing attack. In spoofing attack a speaker's speech is produced in source side and is modified and played back to sound like the speaker's original voice.

Two popular spoofing attack methods typically include a speech synthesis system and a human mimicking. In speech synthesis a source voice sample is manipulated/trained to sound like the target speaker's speech. In human voice mimicking a person tries to generate speech like the target speaker or target's speech is recorded and then played back. Although studies have shown that human can easily distinguished between synthesized and natural speech, it is difficult even for human to distinguish play-back attacks.

One or more embodiments of the present invention use watermarking along with a voice biometric system for hardening and strengthening speaker recognition/verification and using a contrivance/device with embedded security.

In one or more embodiments, a watermark is embedded in a speech signal at a transmitter side for checking the authenticity of the speaker's voice biometric template stored at the receiver side. Due to properties of the watermark, various types of spoofing attack can be prevented. Furthermore, there is possibility to trace the source of attack. That gives a better authenticity of the speaker and improved security to the contact center of the bank or financial services company.

One or more embodiments of the present invention employ a novel concept of using watermarking along with voice biometric system for hardening and strengthening speaker recognition/verification and using a contrivance/device with embedded security.

In one or more embodiments of the present invention a watermark is embedded in a speech signal at a transmitter for checking the authenticity of the speaker's voice biometric template stored at or in a receiver. Due to properties of the watermark, various type of spoofing attack can be prevented. Furthermore, there is possibility to trace the source of attack. That gives a better authenticity of speaker and improved security to the contact center of the bank or financial services companies.

Throughout this document, phrases such such as voice biometrics, voice authentication, speaker authentication and speaker recognition mean, in at least one embodiment, that a ‘voice print’ of a human being is processed to identify and authenticate his/her credentials before allowing any transactions or access to systems set by enterprises/offices.

For voice (or speech) authentication, there is both a physiological biometric component (for example voice tone, pitch, nasal effect etc.) and a behavioural component (for example accent, pause, pace etc.). This makes it very useful for biometric authentication. Authentication attempts to verify that an individual speaking is, in fact, who they claim to be. This is normally accomplished by comparing an individual's ‘live’ voice with a previously recorded “voiceprint” sample of their speech. When the ‘live’ voice is processed by digital system, we also create and verify a watermark embedded with ‘live’ voice using a ‘contrivance’ device to ensure no spoofing or playback or mimicry of original caller is used to conduct any fraudulent transactions.

In at least one embodiment an apparatus is provided comprising a computer processor, and a computer memory. In at least one embodiment, the computer processor is programmed to receive a voice input of a first person and a request for authorization by the first person to access an account from an authorized computer software application; to perform audio watermark recognition technology on the voice input to determine if the voice input satisfies expected audio watermark data stored in the computer memory for a first authorized person; to perform voice biometric technology on the voice input to determine if the voice input satisfies expected voice biometric data stored in the computer memory for the first authorized person; and to produce an output to the authorized computer software application to indicate that the voice input is from the first authorized person, based at least in part on the voice input satisfying expected audio watermark data and expected voice biometric data.

The computer memory may include a database of a plurality of voice prints for a plurality of persons, including a first authorized voice print for the first authorized person, and each voice print may include an audio watermark.

The computer processor may be programmed to receive a set of identification information for the first person, in addition to the voice input of the first person, from the authorized computer software application; to determine if the set of identification information is associated with the first authorized person; and to produce the output to the authorized computer software application to indicate that the voice input is from the first authorized person, based at least in part on the determination that the set of identification information is associated with the first authorized person.

In at least one embodiment of the present invention, a method which may include receiving at a computer processor, a voice input of a first person and a request for authorization by the first person to access an account from an authorized computer software application; using the computer processor to perform audio watermark recognition technology on the voice input to determine if the voice input satisfies expected audio watermark data stored in computer memory for a first authorized person; using the computer processor to perform voice biometric technology on the voice input to determine if the voice input satisfies expected voice biometric data stored in the computer memory for the first authorized person; and producing an output to the authorized computer software application to indicate that the voice input is from the first authorized person, based at least in part on the voice input satisfying expected audio watermark data and expected voice biometric data.

The computer memory may include a database of a plurality of voice prints for a plurality of persons, including a first authorized voice print for the first authorized person; and each voice print may include an audio watermark.

The method may further include receiving a set of identification information for the first person at the computer processor, in addition to the voice input of the first person, from the authorized computer software application; using the computer processor to determine if the set of identification information is associated with the first authorized person; and using the computer processor to produce the output to the authorized computer software application to indicate that the voice input is from the first authorized person, based at least in part on the determination that the set of identification information is associated with the first authorized person.

### BRIEF DESCRIPTION OF THE DRAWINGS

FIG. 1 shows a diagram of an overall architecture of speaker authentication using voice biometrics, as a block diagram of a first method, apparatus, and/or system in accordance with an embodiment of the present invention;

FIG. 2 shows a block diagram of a second method, apparatus, and/or system in accordance with an embodiment of the present invention;

FIG. 3 shows a block diagram of a third method, apparatus, and/or system in accordance with an embodiment of the present invention;

FIG. 4 shows a block diagram of a fourth method, apparatus, and/or system in accordance with an embodiment of the present invention;

FIG. 5 shows a block diagram of a fifth method, apparatus, and/or system in accordance with an embodiment of the present invention;

FIG. 6 shows a block diagram of a sixth method, apparatus, and/or system in accordance with an embodiment of the present invention;

FIG. 7 shows a block diagram of a seventh method, apparatus, and/or system in accordance with an embodiment of the present invention;

FIG. 8 shows a block diagram of an eighth method, apparatus, and/or system in accordance with an embodiment of the present invention;

FIG. 9 shows a block diagram of a ninth method, apparatus, and/or system in accordance with an embodiment of the present invention;

FIG. 10 shows a block diagram of a tenth method, apparatus, and/or system in accordance with an embodiment of the present invention;

FIG. 11 shows a block diagram of an eleventh method, apparatus, and/or system in accordance with an embodiment of the present invention;

FIG. 12 shows a block diagram of a twelfth method, apparatus, and/or system in accordance with an embodiment of the present invention; and

FIG. 13 is a diagram of a method, system, and apparatus in accordance with an embodiment of the present invention;

### DETAILED DESCRIPTION OF THE DRAWINGS

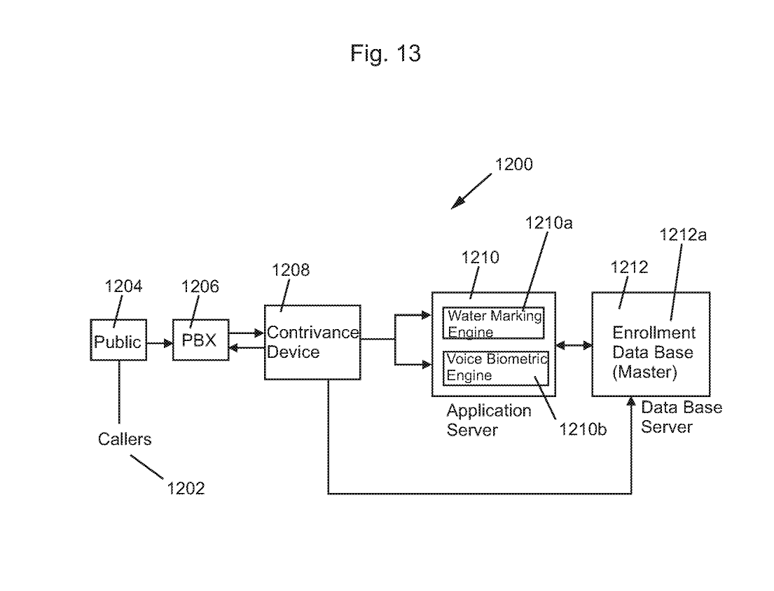

FIG. 13 is a diagram of a method, system, and apparatus 1200 in accordance with an embodiment of the present invention. The method, system, and apparatus 1200 includes callers 1202, public 1204, PBX (private branch exchange telephone system) 1206, contrivance device 1208, application server 1210, and data base server 1212. The contrivance device 1208 may include a computer processor, computer memory, and computer software stored within computer memory which is executed by the computer processor. The application server 1210 may include a water marking engine or computer software 1210a, and a voice biometric engine or computer software 1210b. The application server 1210 may include a computer processor, computer memory, and computer software stored within computer memory which is executed by the computer processor.

The data base server 1212 may include enrollment data base (master) or computer software 1212a. The data base server 1212 may include a computer processor, computer memory, and computer software stored within computer memory which is executed by the computer processor.

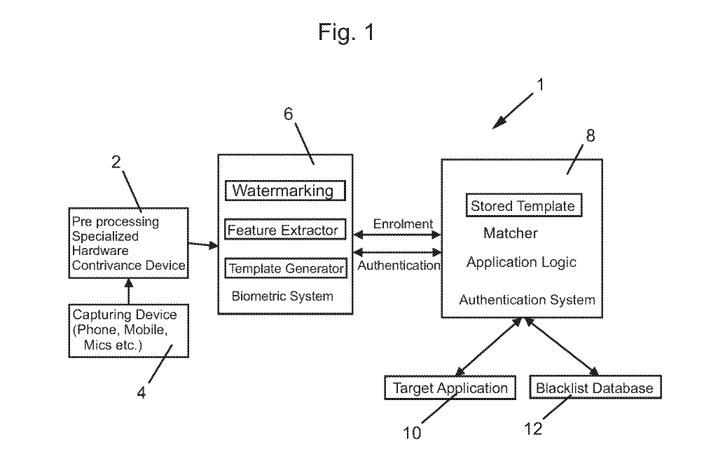

FIG. 1 shows a block diagram of a method, apparatus, and/or system 1 in accordance with an embodiment of the present invention. The method, apparatus, and/or system 1 includes a pre-processing specialized hardware contrivance device 2, a capturing device 4, a biometric system 6, a stored template 8, a target application 10, and a blacklist database 12.

The pre processing specialized hardware contrivance device 2 may be a computer processor programmed with computer software to do water marking and demarking as an embedded system with encryption for preventing hacking or break of security of database with master voice prints.

The capturing device 4 may be a smart mobile phone, microphones of headsets with laptops or desktops using secured voice over IP connections.

The biometric system 6 may include a watermarking module, a feature extractor module, and a template generator for unique voice print creation of user for later verifications/authentications.

The stored template 8 may be a template stored in a computer memory, which may include a matcher computer program, an application logic computer program, and an authentication system computer program.

The target application 10 may be a computer program stored in computer memory and executed by a computer processor. This is normally part of enterprise application (for example banking transaction or trading etc.) which requires security systems and needs proper authentication of user before granting access. The blacklist database 12 may be stored in a computer memory. for identification of known fraudster claiming fake identity or a person who is under Federal Surveillance and alert the authorized person that a ‘blacklisted’ person is calling into the system to take appropriate preventive methods to stop them for accessing the systems for any transactions.

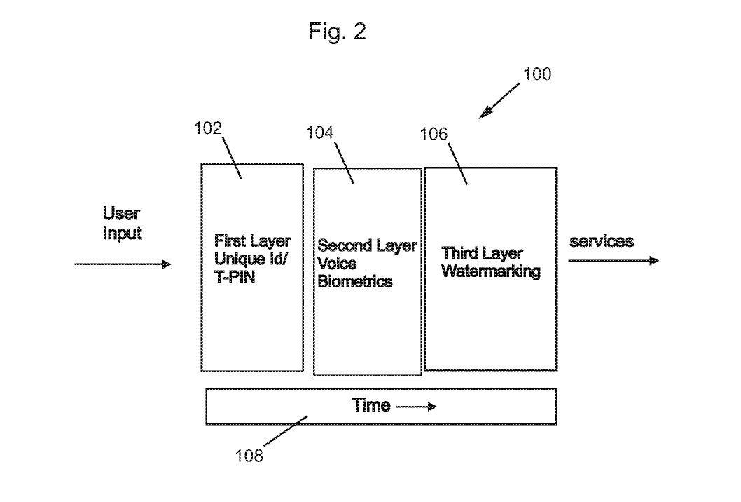

FIG. 2 shows layers of security available for enterprises to select as a block diagram of an apparatus, method, and/or system 100, which may include Layers 102, 104, and 106, each of which may be a computer program stored in a computer memory and executed by a computer processor. First Layer 102 normally may include a Unique ID (identification)/T-PIN computer program for identifying a Unique ID and/or T-PIN which is existing for most of phone based access to applications. Second Layer 104 is proposed for Biometric security, may include a voice biometrics computer program stored in a computer memory and executed by a computer processor. Third Layer 106, is proposed as “anti-spoofing” tool, may include a watermarking computer program stored in a computer memory and executed by a computer process.

In the apparatus, method, and/or system 100, a user provides input to First Layer 102, such as the user's identification and/or T-PIN. This exists already in many phone based services/access offered by enterprises. Now we are adding an additional layer of security in form of Voice Biometrics capture, where user's actual voice input is given to our system, through a voice input device like smartphone or microphone of headsets connected to laptop/desktop as voice capturing device. The First Layer 102 and the Second Layer 104, examine the identification and/or T-PIN inputted, and the voice inputted, and apply watermarking from the the contrivance device connected over the network, in the Third Layer 106. Component 108 represents time to determine if the caller is taking too much of time to complete the call by comparing with previous average time taken by original caller. Normally ‘Imposters’/“Fraudsters” take a longer time than original caller to answer a surprise question asked by system before authentication.

For analysis, let us consider there are ‘n’ authentication layers with security level S1, S2, . . . Sn. Then the security of the system (S) can be expressed as shown in FIG. 2 with flexibility given to enterprise/customer to opt for layers of security they want to adopt, based on the security needs of the organization and/or authentication process.

Thus an authentication apparatus, method, and/or system in accordance with one or more embodiments of the present invention, which may be called “SVoiz” coupled with time factor will be many times strong and robust than a simple password based authentication system or OTP (one time password) based authentication. Hence it is possible to achieve a fool proof or substantially fool proof authentication method by the use one or more embodiments of the present invention to prevent any fraudulent transactions using stolen credentials of user or man-in-the-middle attacks of protected system to siphon valuable information/money transfer etc.

Moreover, the entire solution of one or more embodiments of the present invention is hack-proof and robust due to the embedded nature of the application and encryption as part of the contrivance/device being deployed along with CTI (computer telephony integration) hardware of the contact centre or PBX (public branch exchange, public telephone switchboard) in any organization that requires the additional security using voice biometrics along with watermarking. Thus, this is a unique product, which is not available with any vendor or commercially provided by any company.

Speaker recognition is a process whereas speaker identification and speaker verification refer to definite tasks. For the areas in which security is a foremost concern, speaker recognition technique is one of the most useful recognition techniques, as it is biometric and does not require any specific/special device at user end, compared to fingerprint or iris scan as biometrics tools. However, there are possibilities of spoofing attack in voice recognition system, which break the voice biometric security system. By using the watermark technology and embedding a watermark with the voice biometric information can provide a robust and secured mechanism for authentication. Also, as an embedded device, which is secured with encrypted communication, one or more embodiments of the present invention, which may be called “SVoiz” are completely or substantially completely secured at multiple levels.

Today organizations are moving away from traditional TPIN (Telephone Personal Identification) based security systems to a more complex and more fool proof fourth generation methods using multiple means of verification and unique characteristics of individuals using biometric features. The system makes check of multiple factors; at least one of them will be unique to the user and checked out biometrically, before the authentication.

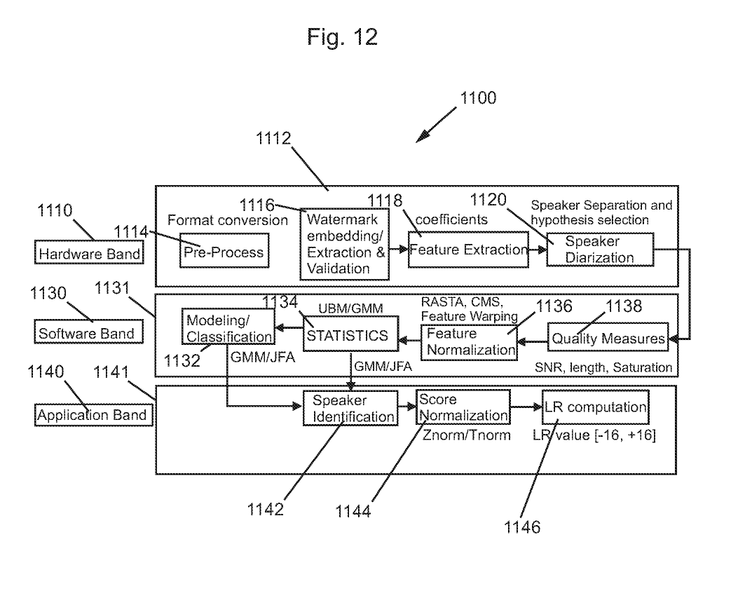

In one or more embodiments of the present invention, also called “SVoiz System” voice biometrics and watermarking is used along with other user information as second and third factor authentication system or systems, along with first factor in form of T-PIN or Customer id. Voice biometrics, itself creates a secure environment for authentication, but in one or more embodiments of the present invention or “SVoiz”, the voice biometrics combined with watermarking is used in addition to conventional authentication methods. Thus the SVoiz system in one or more embodiments of the present invention combines and coordinates multiple security bands. The most important aspect, in one or more embodiments, is that each of these bands, such as the hardware band 1110, the software band 1130, and the application band 1140 shown in FIG. 12, functions sequentially and independently. Also, the same is delivered using the contrivance device 1208 shown in FIG. 13 that can work with most of the PBX/CTI environment.

A typical SVoiz system in accordance with one or more embodiments of the present invention and as shown in FIG. 12 and FIG. 13, authenticates a customer based on the combination of (a) something they know, a TPIN (telephone personal identification) or unique identifiers (mobile/Account/card Numbers), (b) something they have, their inherent and unique voice biometrics characteristics, (c) something the system generates and embeds into the above, i.e. watermarking image or instantly generated code using audio, and (d) how fidelity of information security will be improved after SVoiz is applied to secure Information dissemination and transactions in a contact center/phone environment.

One or more embodiments of the present invention, also called “SVoiz” rely on multi-level (layer) authorization. Logically the layers are cascaded where each layer will functionally constitute a logical pass gate. Thus the security level will be multiple times better than the security provided by individual layers. Eventually, the customer needs to satisfy all these layers to access the information or complete the transaction.

One or more embodiments of the present invention, also called “SVoiz” will deliver a robust authentication system because: (1) It uses in-band authentication, where the mode of operation, functionality and process medium for each security layer is independent of each other but does not rely on external sources other than the current channel for authorisation. (2) in one of the layers, certain unique characteristics of the user are checked using a biometric method i.e. by using voice biometrics, (3) A watermarking factor is also introduced so that the authentication process becomes robust and controls spoofing, and (4) as a final measure the transaction or information should be completed in a specific time limit, thus introducing a time factor.

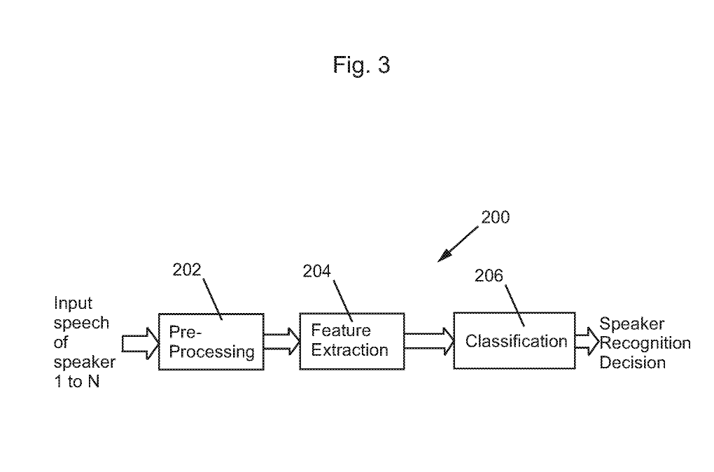

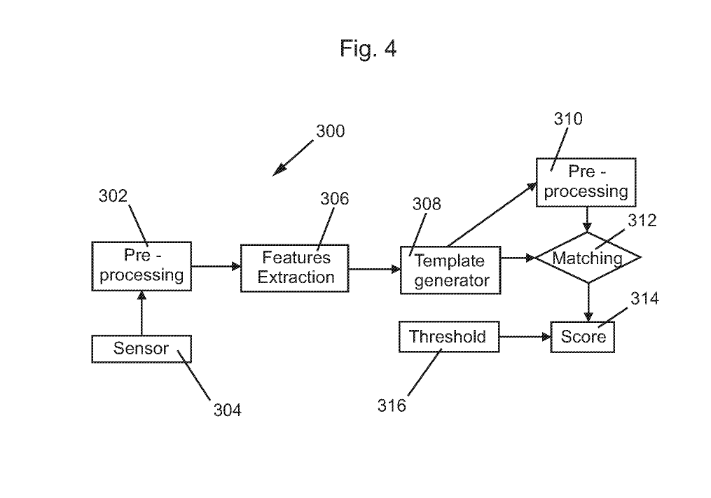

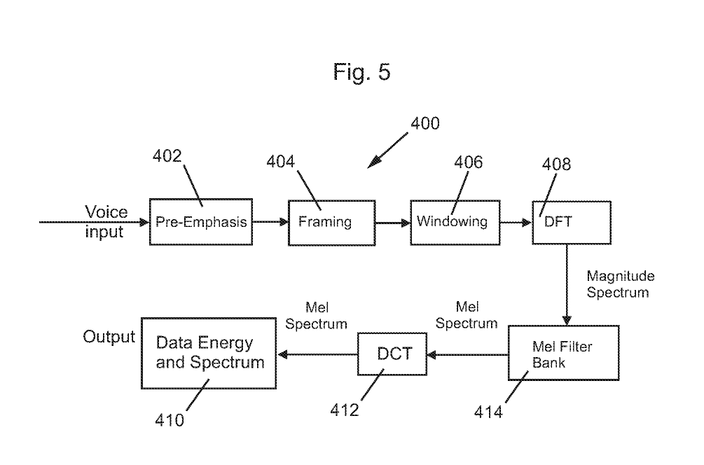

FIG. 3 explains biometric method of speaker recognition process, shows a block diagram of an apparatus, method, and/or system 200 which includes pre-processing module 202, feature extraction module 204, and classification module 206. The modules 202, 204, and 206 may be computer programs stored in a computer memory and executed by a computer processor. Actual voice input or speech may be input to pre-processing module 202 by 1 to N speakers, and may be processed by module 202 using noise cancellation and format conversion to process further. The output of module 202 may be supplied to module 204 which extracts features such as separation of Nasal and Vocal tract characteristics using methods explained in the FIG. 5. The output of feature extraction 204 may be provided to module 206 as an input. Module 206 does the diarisation of original speaker voice from computer generated voice (prompts) or Agent at contact centre. Also, separates multiple speakers, in case of audio conference or multi-party transactions with uqiue voice for each caller and a speaker recognition decision may be determined at the output of module 206 to get the ‘likelihood’ ratio of the true caller (whose voice print is enrolled) as explained further in FIG. 4.

FIG. 3 shows a basic model of speaker recognition system of an enrolled/authorized users, using three phases that is part of pre-processing module 202, feature extraction module 204, and classification module 206, to obtain a speaker recognition decision such as authentic or not authentic. Each of these steps and internal functions are explained in detail as FIGS. 4, 5 and 6 with sub-components explained in accompanying text.

A commonly used mobile or landline phone's built in microphone may be used as a sensor. Sensor data is given to pre-processing block or module 202. After finding start point and end point in pre-processing, the voice features are in three dimensional entity, it varies both in terms of signal strength, over a spectrum of frequencies, and over a period of time. Together these three dimensions come together to form a complex and unique voice ‘print’ template, which are extracted frame by frame in module 204 and it will be stored as template in voice print template database in one or more computer memories. This process can be online as well as offline i.e. the templates can be generated one by one as the speaker calls or can be generated using voice call logs. Thus the extracted feature data is stored in template database in one or more computer memories. This procedure is called as Enrolment, and is also called a “training” phase.

During the recognition (also called testing) phase one of the N speakers will speak and this data will be given to the pre-processing block or module 202 to extract the features at module 204 and prepare a template. Now this template will be matched with the template database in one or more computer memories, and the best match will be considered on the basis of a best score to identify the true speaker by classification module 206.

FIG. 4 is the technical expansion of 202 in FIG. 3 with 300 explaining ‘Extraction’ process, including pre-processing module 302, sensor 304, features extraction module 306, template generator 308, threshold module 316, pre-processing module 310, matching module 312, and score module 314. The components 302, 306, 308, 310, 312, and 314, may be computer programs stored in one or more computer memories and executed by one or more computer processors. When a caller calling claims his identity is correct, the nasal tract and vocal tract features are extracted and compared with original voice print stored on the system.

The property of speech signal can change relatively slowly with time. So that short time analysis is needed in speech pre-processing and can be done is pre-processing module 302. In speech pre-processing, such as module 302 of FIG. 4, this short time segment is considered as frame and the frame size is taken as ten milliseconds to forty milliseconds so that variation of speech signal is observable in short time. Speech is divided in number of frame in which all the frame Short Time Energy (STE) and Zero Crossing Rates (ZCR) is measured. If the energy of any frame is higher than the threshold then it is considered as signal frame. If the energy is less than threshold then it is considered as silent period. So, energy is widely used for the measurement of start and end point of any speech signal. But for weak fricative it is not possible to find the start and end point by simply finding the energy only. ZCR is used for finding weather the frame is voiced or unvoiced. If the ZCR counts are found to be higher, then it is tagged as unvoiced frame and if ZCR counts are less, then it is tagged as “voiced frame” (Frame). Also for silent period the ZCR counts are always less than the unvoiced sound. So, based on this STE and ZCR one can accurately find start point and end point of any speech signal. Now this speech is applied to the next phase called as feature extraction technique.

FIG. 5 shows a block diagram of an apparatus, method, and/or system 400 including pre-pre-emphasis module 402, a framing module 404, a windowing module 406, a Discrete Fourier Transform (DFT) module 408, a data energy and spectrum module 410, a Discrete Cosine Transform (DCT) module 412, and a mel filter bank 414. The components 402, 404, 406, 408, 410, 412, and 414, may be computer programs stored in one or more computer memories and executed by one or more computer processors. This is essentially done using creation of vector files from the features and comparing with vector files from stored characteristics by arriving at a coefficient of the voice to be recognized with stored voice print.

FIG. 5 shows a popular feature extraction technique, which is called Mel Frequency Cepstral Coefficient (MFCC), feature extraction technique. A block diagram of an MFCC feature extraction is shown in FIG. 5. This coefficient technique has great success in speaker recognition application. The MFCC is the most evident example of a feature set that is extensively used in speech recognition. As the frequency bands are positioned logarithmically in MFCC, it approximates the human system response more closely than any other system. Technique of computing MFCC is based on the short-term analysis, and thus from each frame a MFCC vector is computed. In order to extract the coefficients the speech sample or voice input is taken as the input at the pre-emphasis module 402, framing is applied by module 404, and windowing by module 406 to minimize the discontinuities of a signal. Then DFT (Discrete Fourier Transform) is used to generate a Mel filter bank at module 414. Then a DCT (Discrete Cosine Transform) is applied by module 412 to signal and then data energy and spectrum is obtained by module 410 and supplied to output of 410. First, the signal is split into short time frames, done as part of Pre-processing (302 of FIG. 4). For each of these windows, we take a Discrete Fourier Transform. The powers of this spectrum are mapped onto the Mel scale, a logarithmic curve that models pitches that are typically heard as equal distance from each other. We take the log of the powers at each of the mel frequencies, and perform a discrete cosine transform. The features we extract, or MFCCs, are the coefficients of the spectrum that we get from the cosine transform, to get Data Energy & Spectrum to be processed by next stage of apparatus, which is LPC.

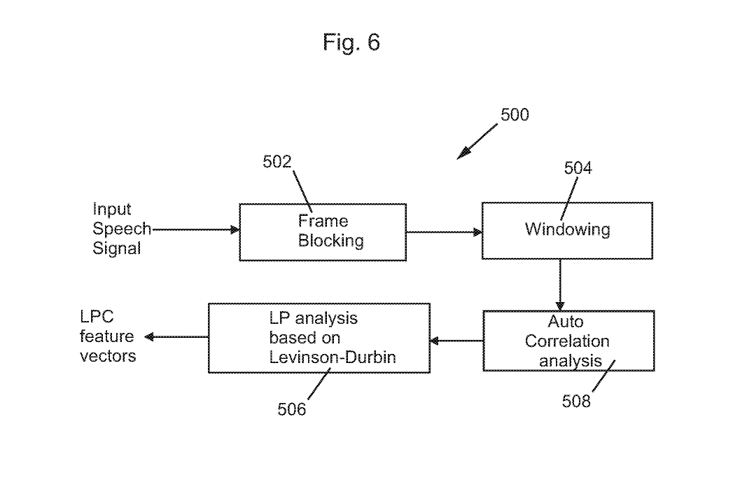

FIG. 6 shows a block diagram of an apparatus, method, and/or system 500 including frame blocking module 502, a windowing module 504, a Linear Prediction Coding (LPC) analysis based on Levinson-Durbin module 506, and an auto correlation analysis module 508. The components 502, 504, 506, and 508 may be computer programs stored in one or more computer memories and executed by one or more computer processors.

Linear prediction coding represents the spectral envelope of a of speech in compressed form, using the information of a linear predictive model. It is one of the most powerful speech analysis techniques, and one of the most useful methods for encoding good quality speech at a low bit rate and provides extremely accurate estimates of speech parameters._LPC is a mathematical computational operation which is linear combination of several previous samples. LPC of speech has become the predominant technique for estimating the basic parameters of speech. It provides both an accurate estimate of the speech parameters and it is also an efficient computational model of speech.

Although apparently crude, this model is actually a close approximation of the reality of speech production. The glottis (the space between the vocal folds) produces the buzz, which is characterized by its intensity (loudness) and frequency (pitch). The vocal tract (the throat and mouth) forms the tube, which is characterized by its resonances, which give rise to formants, or enhanced frequency bands in the sound produced. Hisses and pops are generated by the action of the tongue, lips and throat during sibilants and plosives. LPC analyzes the speech signal by estimating the formants, removing their effects from the speech signal, and estimating the intensity and frequency of the remaining buzz. The process of removing the formants is called inverse filtering, and the remaining signal after the subtraction of the filtered modeled signal is called the residue.

The numbers which describe the intensity and frequency of the buzz, the formants, and the residue signal, can be stored or transmitted somewhere else. LPC synthesizes the speech signal by reversing the process: use the buzz parameters and the residue to create a source signal, use the formants to create a filter (which represents the tube), and run the source through the filter, resulting in speech.

Because speech signals vary with time, this process is done on short chunks of the speech signal, which are called frames; generally 30 to 50 frames per second give intelligible speech with good compression.

The basic idea behind LPC is that a speech sample can be approximated as a linear combination of past speech samples. Through minimizing the sum of squared differences (over a finite interval) between the actual speech samples and predicted values, a unique set of parameters or predictor coefficients can be determined. These coefficients form the basis for LPC of speech. FIG. 6 shows the steps involved in LPC (Linear Predicting coding) feature extraction. An input speech signal has frames defined at module 502, windowing occurs at module 504, auto correlation analysis is done at module 508, and LP analysis based on Levinson-Durbin is done at module 506 to obtain LPC feature vectors, which forms the input for Classification to do matching.

One classification technique which can be used by Matching Engine as well as in module 806, to detect spoofing, may include dynamic time warping, which is a popular method of classification. Dynamic time warping is used specifically to deal with variance in speaking rate and variable length of input vectors because this method calculates the similarity between two sequences which may vary in time or speed. To normalize the timing differences between test utterance and a reference template, time warping is done non-linearly in time dimension. After time normalization, a time normalized distance is calculated between the patterns. The speaker with minimum time normalized distance is identified as an authentic speaker.

Depending on the signal strength and noise to signal ratio, we will use other well-known classification techniques that may be used by module 806, may include (a) Gaussian Mixture Model (GMM) (b) Support Vector Machines (SVM) (c) and Hidden Markov Model (HMM). This depends on client side signal strength, frame availability and compression etc.

Now that Voice Biometrics extraction and identification is done using the above steps, in order to make the security to a higher level, in at least one embodiment of the present invention, a ‘watermarking’ apparatus is used in conjunction with Voice Biometric features of the caller for identification. Using Watermarking prevents any playback attacks as well as spoofing possibilities, which are identified as possible vulnerabilities of Voice biometric security systems. The contrivance proposed is an embedded hardware box/contrivance device connected to a voice n/w of an operator or PBX, which generates and matches the water marking along with Voice Biometric features of the caller to ‘pass’ or ‘fail’ the genuine identity of the caller, who calling with proper user credentials, based on results of the authentication from Svoiz.

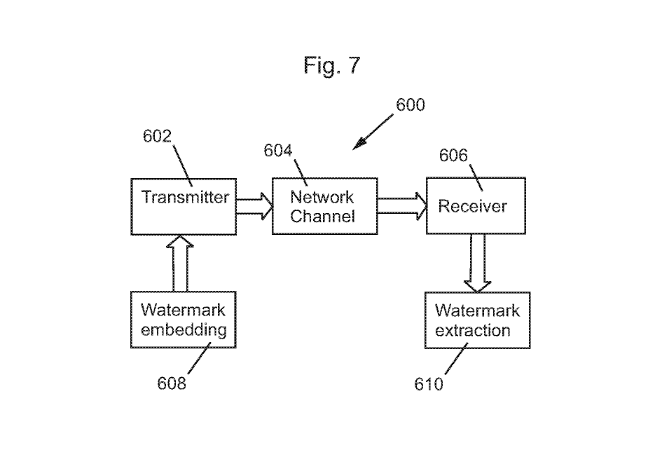

FIG. 7 shows “Watermarking” as additional layer of security in conjunction with voice biometrics as a block diagram of an apparatus, method, and/or system 600 including a transmitter 602, a network channel 604, a receiver 606, a watermark embedding module 608, and a watermark extraction module 610. The components 608 and 610 may be computer programs stored in one or more computer memories and executed by one or more computer processors. The steps of watermarking embedding algorithm are expressed as follows: (a) Watermark embedding (b) Watermark extraction

FIG. 7 shows fundamental architecture of digital speech watermarking. Watermarking is the technique and art of hiding additional data (such as watermarked bits, logo and text message) in a host signal which includes image, video, audio, speech, text, without any perceptibility of the existence of additional information. The additional information which is embedded in the host signal should be extractable and must resist various intentional and unintentional attacks.

Digital watermarking is a technique to embed information into the underlying data. A digital watermark can be created from user or transaction specific information, which can be embedded in the speech. The embedded information can then be detected and verified at the receiver side. Most of the multimedia digital signals are easy to manipulate that led to a need for security of these signals. Using digital watermarking techniques the security requirements such as data integrity, data authentication can be met.

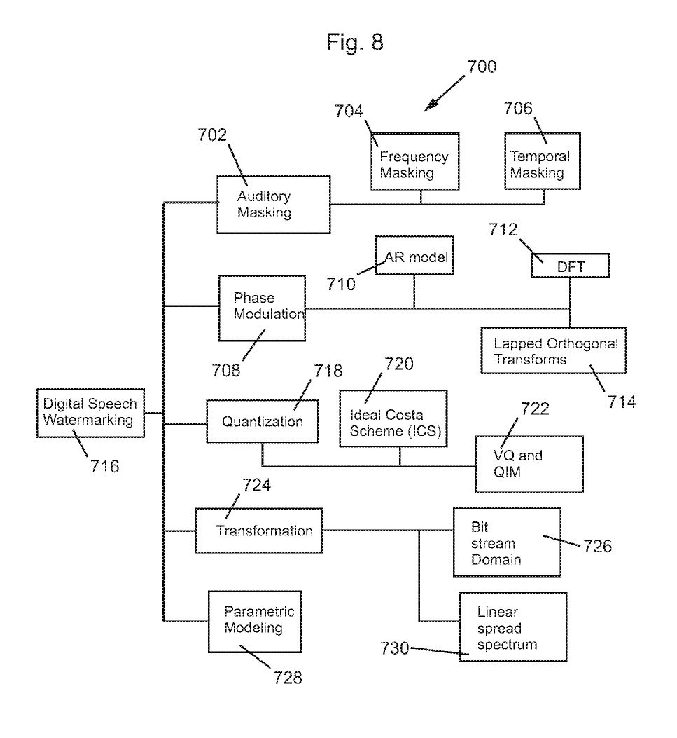

Digital speech watermarking process proposed as part of one or more embodiments of the present invention is depicted in FIG. 7. A signal is embedded with a watermark by module 608, the signal is transmitted with the watermark by transmitter 602 via the network channel 604, and then received by a receiver 606. The watermark is extracted by module 610. Each of these steps are further detailed as explanation to process adopted in FIG. 8, 9, 10 including how Anti-Spoofing is done using a speech watermark technique. There are possibility of spoofing and attack in the speaker recognition system such like whenever the input side or sensor side the claim speaker data is already know the watermark of the system so that playback attack is possible in input side which make spoof to the system.

FIG. 8 shows watermark for Anti-Spoofing attack as a block diagram of an apparatus, method, and/or system 700 including auditory masking 702, frequency masking 704, temporal masking 706, phase modulation 708, AR model 710 (Author Representation—AR), DFT 712, lapped orthogonal transforms 714, digital speech watermarking 716, quantization 718, ideal costa scheme (ICS) 720, and VQ (Voice Quality), QIM (Quantization Index Modulation) 722, transformation 724, bit stream domain 726, parametric modeling 728, and linear spread spectrum 730. The components 702, 704, 706, 708, 710, 712, 714, 716, 718, 720, 722, 724, 726, 728, and 730 may be computer programs stored in one or more computer memories and executed by one or more computer processors. In the watermarking-communications mapping, the process of watermarking is seen as a transmission channel through which the watermark message is being sent, with the non-voiced host signal being a part of that channel. Frequency masking approach has been used to embed the watermark signal components into high frequency sub-band of the host signal. We are using the long-known fact that, in particular for non-voiced speech and blocks of short duration, the ear is insensitive to the signal's phase.

FIG. 8 presents an overview of source and extraction module methods, apparatuses, and systems for digital speech watermarking. QIM (quantization index modulation) technique that operates on the DFT (discrete Fourier transform) coefficients. The method is tuned for the speech domain by its exponential scaling property, which targets the psychoacoustic masking functions and band-pass characteristics. QIM methods embed the information by re-quantizing the signals, in generalization some methods modulate the speech signal or one of its parameter according to the watermark data. Auditory masking describes the psycho-acoustical the principle of auditory masking is exploited either by varying the quantization step size or embedding strength in one way or the other, or by removing masked components and inserting a watermark signal in replacement principle that some sounds are not perceived in the temporal or spectral vicinity of other sounds In particular, frequency masking (or simultaneous masking) describes the effect that a signal is not in the presence of a simultaneous louder masker signal at nearby frequencies. There is no perceptual difference between different realizations of the Gaussian excitation signal for non-voiced speech. It is possible to exchange the white Gaussian excitation signal by a white Gaussian data signal that carries the watermark information. The signal thus forms a hidden data channel within the speech signal.

In terms of source and extraction module for digital speech watermarking at least the below techniques can be used (1) blind speech watermarking which does not need any extra information such as original signal, logo or watermarked bits for watermark extraction; (2) semi-blind speech watermarking which may need extra information for the extraction phase like access to the published watermarked signal that is the original signal after just adding the watermark; and (3) non-blind speech watermarking which needs the original signal and the watermarked signal for extracting watermark. For any watermarking approach, following steps are performed:

(a) The important step in the processing of the signal is to obtain a frequency spectrum of the input signal. The information in the frequency spectrum is used for extracting features such as high frequency components. One method to obtain a frequency spectrum is to apply a Fast Fourier Transform (FFT). The digital input signal undergoes a transformation that outputs a collection of FFT coefficients termed “host vectors” or “host signals” or “cover signal”.

(b) The noise has been removed using wiener filter and then watermark signal is transformed using logarithmic function.

(c) Determine the center of the density of high frequency input signal. Then, the watermark embedding is performed on high frequency components of the host signal using frequency masking method to form watermarked signal.

(d) After the added pattern is embedded, the watermarked work is usually distorted during watermark attacks. We model the distortions of the watermarked signal as added noise. This is not audible to human ears. But, systems detect the same and recognize the true caller.

Once a signal has been watermarked, next step is to deal with the extraction of the watermark sequence. However, because a digitally watermarked signal is obtained by invisibly hiding information into the host signal. The password/secret message is recovered using an appropriate decoding process. The challenge is to ensure that the watermarked signal is perceptually indistinguishable from the original and that the message be recoverable.

Each of the modules 702, 704, 706, 708, 710, 712, 714, 718, 720, 722, 724, 726, 728, and 730 may be used separately or with other modules of FIG. 8 as source and extraction modules for digital speech watermarking. Watermark extraction has the following steps:

(a) The digital watermarked signal undergoes a transformation that outputs a collection of coefficients (Inverse Fast Fourier Transform i.e. IFFT).

(b) The high frequency components of the watermarked signal are extracted.

(c) Then, antilog of the extracted watermark is performed to form recover watermarked signal.

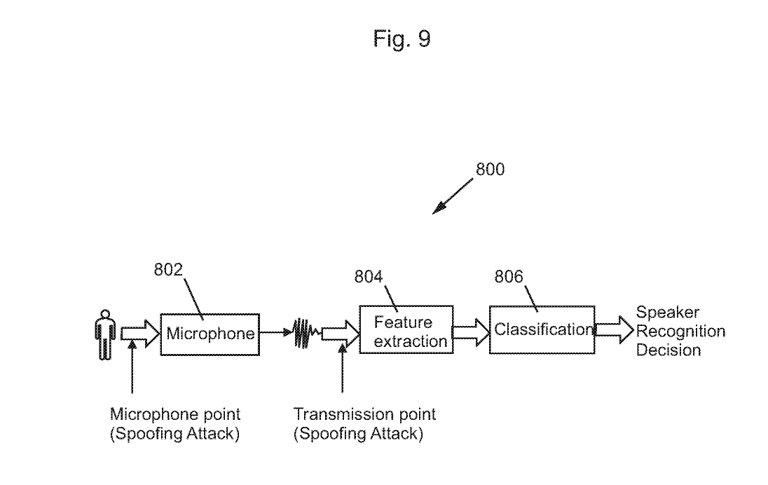

FIG. 9 shows a possible spoofing attack in speaker recognition system as a block diagram of an apparatus, method, and/or system 800 including microphone 802, feature extraction module 804 (same as in FIG. 4, 306), and classification 806 (linked to FIG. 6 output). The components 804 and 806 may be computer programs stored in one or more computer memories and executed by one or more computer processors. There are possibilities of spoofing and attack in a speaker recognition system either on the input side or sensor side by an imposter who already knows the watermark of the system.

There is also a possibility to attack at the transmission line with a replay attack or direct attack to the system. To protect the system from such attack we can use the watermark technology at the transmitter side as well as the receiver side. In FIG. 9, a spoofing attack may be presented at the input of microphone 802, or at the transmission point at input of feature extraction module 804. This may impact the classification module 806 decision of whether this is an authentic speaker.

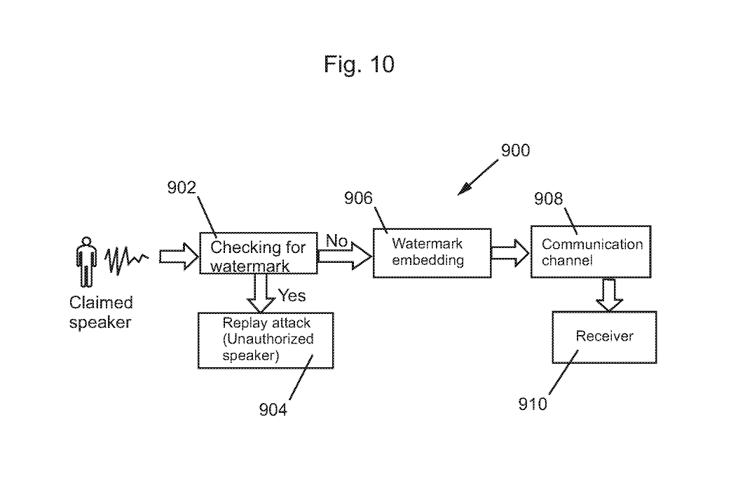

FIG. 10 shows a possible anti-spoofing attack method at transmitter, as a block diagram of an apparatus, method, and/or system 900 including checking for watermark module 902, replay attack (unauthorized speaker) module 904, watermark embedding module 906, communication channel module 908, and receiver 910. The components 902, 904, 906, and 908 may be computer programs stored in one or more computer memories and executed by one or more computer processors. The apparatus, and system 900 using digital speech watermarking at a transmitter 602 in FIG. 7. By using digital speech watermarking for authentication, it is possible to authenticate or verify authenticity of the speaker on a receiver side. FIG. 10 shows a proposed system on a transmitter side. As seen, first the speech signal of a purported speaker is checked for available watermark at module 902, if a watermark is present in the purported speech signal, it means the source of caller claiming the identity given to system is Genuine. Otherwise, signal has already been used (replay attack) so that the speaker is unauthorized and rejected by module 904. If a watermark is not present the authentic watermark is embedded by module 906 as an anti-spoofing attack, and sent out via the communication channel 908 to the receiver 910.

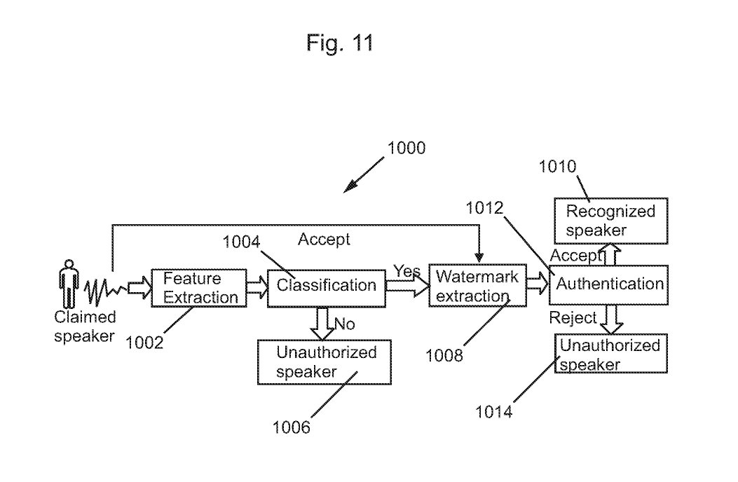

FIG. 11 shows combined diagram of one or more embodiments of the present invention where the speaker recognition based on voice biometric features, is combined with a watermarking system, as a block diagram of an apparatus, method, and/or system 1000 including feature extraction module 1002, classification module 1004, unauthorized speaker module 1006, watermark extraction module 1008, recognized speaker module 1010, authentication module 1012, and unauthorized speaker module 1014. The components 1002, 1004, 1006, 1008, 1010, 1012, and 1014 may be computer programs stored in one or more computer memories and executed by one or more computer processors. As described in FIGS. 2 to 10, the whole system is integrated as a single contrivance/device, as our invention.

FIG. 11 is a diagram of speaker recognition with an anti-spoofing attack detector by using digital speech watermarking, in accordance with an embodiment of the present invention as integrated device. On date, there are no systems, which have the combination of Voice Biometrics based Speaker recognition and watermarking to prevent spoofing thru system synthesized voice or mimicry artists. The system on the whole is unique with Genuine user/Speaker is identified uniquely and differentiated from fraudsters. The Speech Watermaking system is embedded in our contrivance device with 128 bit encryption security for prevention of any hacking or break-in to manipulate the watermark by hackers. This embodiment is our invention that can work with any CTI/PBX or call centre infrastructure or service agencies.

Image watermark can also be enabled to give a flexibility for user to opt for certain transactions with Image. Also, SVoiz will be available as Soft-switch instead of embedded hardware, for those customers, who need low-cost′ but with a degree of lower security requirements (such as Voice Biometric Attendance from Remote site for Security guards or outsourced staff etc.). The proposed embodiment can be either an embedded device installed on the customer/enterprise network or as soft-switching device, based on the needs of the customer.

FIG. 12 summarizes one or more embodiments of the present invention shown as hardware, computer software and application bands, as a block diagram of an apparatus, method, and/or system 1100 including a hardware band 1110 shown in block 1112, a software band 1130 shown in block 1131, and an application band 1140 shown in block 1141.

The hardware band 1110 in block 1112 may include pre-process module 1114 (explained in detail with 302), watermark embedding/extraction/validation module 1116 (explained in 610), feature extraction module 1118 (explained in 306), and speaker classification/diarization module 1120 (explained in 510).

From Speaker Diarisation for the signal obtained for original caller, where quality measures module 1138 is applied (Signal to Noise Ratio, Length & speech features etc.). The output of Quality measures gets to feature normalization module 1136 (RASTA—a Bandpass filter, CMS—Ceptral Mean Subtraction filter & Feature warping) to obtain STATS (Statistical pattern recognition using Universal Background Model (UBM) and Gaussian Mixture Model (GMM)—for predicting the matching user for signal inputs/voice spectrum passed) module 1134. Statistics obtained is passed to 1132 (to predict and classify the caller using Joint Factor Analysis (JFA) combined with GMM for Speaker Identification) and obtain the Speaker Recognition.

The application band 1140 in block 1141 may include speaker identification module 1142 (Based on the JFA/GMM model, predict the speaker & match with existing recorded score), score normalization module 1144 (using Zero Normalisation (Znorm) and Test Normalisation (Tnorm), as part of Non-Linear analysis techniques to feed to get the Likelyhood Ratio (LR) for the caller), and LR computation module 1146 (where the ratio of normalized ‘live’ caller score is compared with ‘stored’ caller score and based on the threshold set for ‘approval’, validation is ‘pass’ or ‘fail’).

Modules 1114, 1116, 1118, 1120, 1132, 1134, 1136, 1138, 1142, 1144, and 1146 may be computer programs stored in one or more computer memories and executed by one or more computer processors. Spoofing attacks are the main aim for fraudsters/cheaters, who want to break-in to security systems of Financial institutions or Government n/w or data access etc., using remote or online speaker recognition system. Digital watermarking can successfully be used for various types of spoofing attack and improve accuracy of speaker recognition system in case of unsecure channels like voice and data, which is very vulnerable on date.

The performance of anti-spoofing system using watermark with speaker recognition and genuine caller is measured, in at least one embodiment using the following performance parameters.

(a) Identification Rate

Identification Rate is familiar measurement of the performance of a speaker recognition system.

$$\% Indemtification Rate = \frac{No . of Correctly Indentified trials}{Total No . of Trails} \qquad ( 2 )$$

Normally this should be 90-95% for an uncompromised experience of customers

(b) Signal to Watermark Ratio

Signal to watermark ratio is investigating the effect of the watermark on speaker recognition system.

$$SWR ( ω , {ω}^{′} ) = 10 {log}_{10} \frac{{\sum }_{i = 1}^{N} {ω ( i )}^{2}}{{\sum }_{i = 1}^{N} {[ ω ( i ) - {ω}^{′} ( i ) ]}^{2}} ( dB )$$

Where ω and \acute{ω} are original and watermarked speech signal respectively. This should be >=1 for a good system performance with good security level.

The contrivance/device 1208 in FIG. 13 may have the following hardware specifications. Contrivance/Device 1208 with Embedded System—H/w Specifications:

| Description | Specification |
|---|---|
| CPU/Memory | CPU: ATMEL 400 MHz AT91SAM9G20 (ARM9, w/MMU) Memory: 64 MB |
| | SDRAM, 128 MB Flash (NAND) DataFlash ®: 2 MB, for system recovery |
| Network Interface | Type: 10/100BaseT, RJ-45 connector Protection: 1.5 KV magnetic |
| | isolation |
| COM Ports (RJ45 | COM1: can be set as RS-232, RS-422, or RS-485 COM2,3,4: can be set |
| connector) | RS-232 or RS-485 |
| COM Port | Baud Rate: up to 921.6 Kbps Parity: None, Even, Odd, Mark, |
| Parameters | Space Data Bits: 5, 6, 7, 8 Stop Bit: 1, 1.5, 2 bits Flow Control: |
| | RTS/CTS, XON/XOFF, None RS-485 direction control: auto, by hardware |
| Console & GPIO | Console: Tx/Rx/GND, 115, 200, N81 GPIO: 5x, CMOS level |
| (RJ45 connector) | |
| USB Ports | Host ports: two Client port: one, for ActiveSync Speed: USB 2.0 |
| | compliant, supports low-speed (1.5 Mbps) and full-speed (12 Mbps) data |
| | rate |
| General | WatchDog Timer: yes, for kernel use Real Time Clock: yes Buzzer: |
| | yes Power input: 9~48 VDC |
| Power | 300 mA@12 VDC Dimension: 78 × 108 × 24 mm Operation Temperature: |
| consumption: | 0 to 70 C. (32 to 158 F.) |
| Regulation: | CE Class A, FCC Class A |

The contrivance device 1208 in FIG. 13 may have the following computer software specifications:

VII—Contrivance/Device with Embedded System—S/w Specifications:

| Description | Specification |
|---|---|
| General | OS: WinCE 6.0 core version RAM-based File System: >30 MB free |
| | space available NAND-based File System: >90 MB free space available |
| Ready-to-use | Web Server, including ASP support (users can specify the default |
| Network Services | directory of web pages) Telnet Server FTP Server Remote Display |
| | Control. |
| Enhanced | ifconfig: to modify the network interface settings usrmgr: to create and |
| Command Mode | manage user accounts |
| Utility | update: to update the kernel image and file system |
| | init: to organize the application programs which runs automatically after |
| | system boot-up. |
| | gpioctrl: to control the Matrix-604's GPIOs |
| System Failover | Normally, the custom hardware boots up from its NAND Flash. If the |
| Mechanism | NAND Flash were to crash, the system can still boot up from its Data |
| | Flash. A menu-driven utility will be activated to help users to recover its |
| | NAND Flash. |
| Application | We use Microsoft Visual Studio 2005 for application development. The |
| Development & | custom hardware comes with its own SDK for C/C++ programming |
| Deployment | language. The application program can be transferred to the custom |
| | hardware either by ActiveSync or USB pen drive locally or by FTP |
| | remotely. |

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a computer processor;
a computer memory;
wherein the computer processor is programmed to receive a voice input of a first person and a request for authorization by the first person to access an account from an authorized computer software application;
wherein the computer processor is programmed to subject the voice input to a number of independent layers of security, wherein the number of independent layers of security is programmed to be selected by a user, and wherein the number of independent layers of security is at least one; and
wherein the computer processor is programmed to produce an output to the authorized computer software application to indicate that the voice input is from the first authorized person, based at least in part on the voice input satisfying the number of independent layers of security.

2. The apparatus of claim 1 wherein
the number of independent layers of security include a first layer which uses a password, a second layer which uses voice biometric data, and a third layer which uses audio watermark data.

3. The apparatus of claim 1 wherein
the computer processor is programmed to receive a set of identification information for the first person, in addition to the voice input of the first person, from the authorized computer software application;
wherein the computer processor is programmed to determine if the set of identification information is associated with the first authorized person; and
wherein the computer processor is programmed to produce the output to the authorized computer software application to indicate that the voice input is from the first authorized person, based at least in part on the determination that the set of identification information is associated with the first authorized person.

4. A method comprising the steps of:
receiving at a computer processor, a voice input of a first person and a request for authorization by the first person to access an account from an authorized computer software application;
using the computer processor to subject the voice input to a number of independent layers of security, wherein the number of independent layers of security is programmed to be selected by a user, and wherein the number of independent layers of security is at least one; and
producing an output to the authorized computer software application to indicate that the voice input is from the first authorized person, based at least in part on the voice input satisfying the number of independent layers of security.

5. The method of claim 4 wherein
the number of independent layers of security include a first layer which uses a password, a second layer which uses voice biometric data, and a third layer which uses audio watermark data.

6. The method of claim 4 further comprising
receiving a set of identification information for the first person at the computer processor, in addition to the voice input of the first person, from the authorized computer software application;
using the computer processor to determine if the set of identification information is associated with the first authorized person; and
using the computer processor to produce the output to the authorized computer software application to indicate that the voice input is from the first authorized person, based at least in part on the determination that the set of identification information is associated with the first authorized person.

7. An apparatus comprising
a computer processor;
a computer memory;
wherein the computer processor is programmed to receive a plurality voice of inputs from a plurality of speakers during a training phase;
wherein the computer processor is programmed to store a plurality of voice print templates in a voice print template database in the computer memory corresponding to the plurality of voice inputs during the training phase;
wherein the computer processor during a recognition phase is programmed to receive a first voice input and to prepare a first template, and
wherein the computer processor during the recognition phase is programmed to compare the first template versus the template database and to determine a best match to identify a true speaker of the first voice input, based on a best score.
